(19) United States
(12) Patent Application Publication
(10) Pub. No.: US 2005/0262879 A1
(43) Pub. Date: Dec. 1, 2005

(54) Washing machine

(75) Inventors: Jong Min Kim, Changwon-si (KR); Yang Hwan No, Changwon-si (KR); Han Ki Cho, Changwon-si (KR); Ho Sung Jang, Gyeongsangnam-do (KR); Dong Hoon Kang, Busan (KR); Jung Hoon Kang, Changwon-si (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/033,885

(22) Filed: Jan. 13, 2005

(30) Foreign Application Priority Data
Jun. 1, 2004 (KR) P2004-39567

(51) Int. Cl. D06F 29/00; B08B 3/12

(52) U.S. Cl. 68/3 R; 68/12.26; 68/23 R

(57) ABSTRACT

A washing machine including a gasket having improved durability is disclosed. The washing machine includes a cabinet, a tub provided in the cabinet, storing washing water, a drum rotatably provided in the tub, washing the laundry, a door provided in the cabinet, a gasket provided between the door and the tub, including a bent portion, and a reinforcement member provided in the bent portion of the gasket, preventing the bent portion from being abraded.

This application claims the benefit of Korean Application No. P2004-39567, filed on Jun. 1, 2004, which is hereby incorporated by reference as if fully set forth herein.

### BACKGROUND OF THE INVENTION

1. Field of the Invention

The present invention relates to a washing machine, and more particularly to, a gasket provided between a door and a tub of a washing machine.

2. Discussion of the Related Art

A washing machine is to wash the laundry using a chemical action by detergents and a mechanical impact by a drum. Generally, the washing machine includes a tub provided in a cabinet and a drum rotatably provided in the tub. The cabinet is provided with a door that allows a user to put or take the laundry in or out of the drum. A gasket is provided between the door and the tub to prevent washing water from being leaked into the washing machine. The gasket includes a bent portion of a predetermined size and damps vibration of the tub and the drum using the bent portion.

However, friction occurs between respective inner surfaces of the bent portion due to the vibration of the drum and the tub. In this case, the inner surfaces of the bent portion are abraded, and the bent portion is damaged by this abrasion. For this reason, the washing water is leaked out from the gasket and failure of the washing machine is caused.

### SUMMARY OF THE INVENTION

Accordingly, the present invention is directed to a washing machine that substantially obviates one or more problems due to limitations and disadvantages of the related art.

An object of the present invention is to provide a gasket for a washing machine configured to prevent a bent portion from being abraded.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a washing machine includes a cabinet, a tub provided in the cabinet, storing washing water, a drum rotatably provided in the tub, washing the laundry, a door provided in the cabinet, a gasket provided between the door and the tub, including a bent portion, and a reinforcement member provided in the bent portion of the gasket, preventing the bent portion from being abraded.

The reinforcement member is configured to allow facing inner surfaces of the bent portions to be spaced apart from one another at predetermined intervals so that the facing inner surfaces of the bent portion are not in contact with one another.

The reinforcement member is comprised of at least one rib formed in any one of facing inner surfaces of the bent portion. Preferably, the reinforcement member is comprised of a plurality of ribs formed in any one of facing inner surfaces of the bent portion.

Furthermore, the reinforcement member is comprised of first and second ribs respectively formed in facing inner surfaces of the bent portion. The first and second ribs are arranged to face each other. The first and second ribs may be connected with each other or may be separate members spaced apart from each other.

The bent portion is comprised of a bellows and is oriented toward the door.

In the present invention, the gasket is prevented from being abraded and damaged.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a sectional view illustrating a washing machine according to the present invention;

FIG. 2 is a partial perspective view illustrating a gasket fixed to a tub in a washing machine according to the present invention;

FIG. 3 is a sectional view taken along line I-I of FIG. 2;

FIG. 4 is a partial sectional view illustrating a gasket of a washing machine according to the present invention;

FIG. 5 is a plane view viewed in a direction A of FIG. 4;

FIG. 6 is a partial sectional view illustrating a modified example of a gasket of a washing machine according to the present invention; and

FIG. 7 is a plane view viewed in a direction A of FIG. 6.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

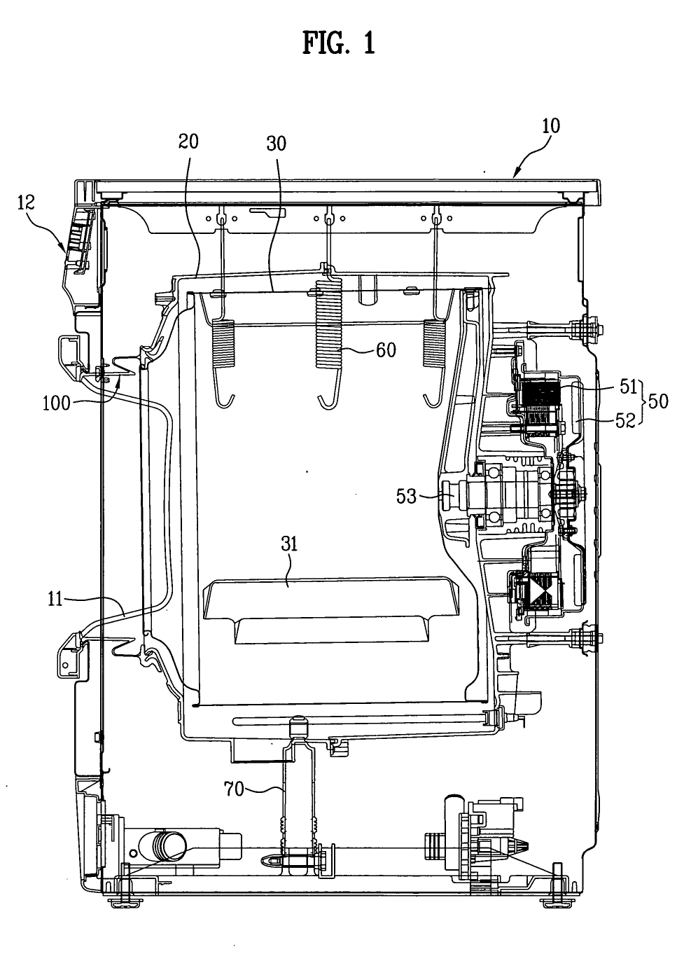

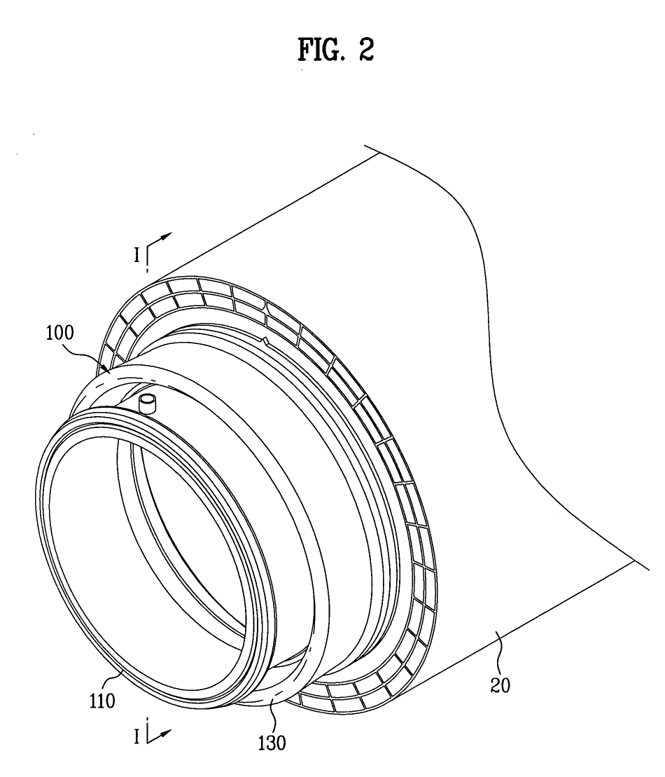

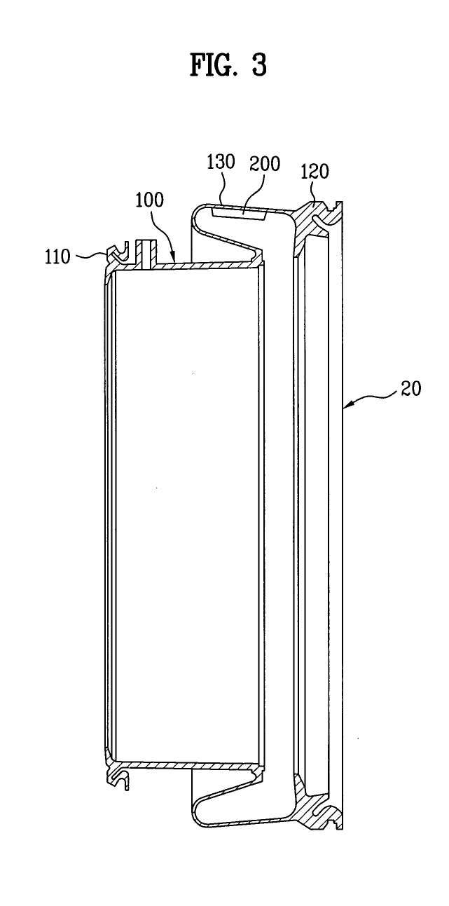

FIG. 1 is a sectional view illustrating a washing machine according to the present invention, FIG. 2 is a partial perspective view illustrating a gasket fixed to a tub in a washing machine according to the present invention, and FIG. 3 is a sectional view taken along line I-I of FIG. 2.

As shown, a washing machine according to the present invention includes a cabinet 10, a tub 20 supported by a damper 70 and a spring 60 in the cabinet 10, a drum 30 rotatably provided in the tub 20, and a driver 50 connected with the drum 30.

The driver 50 includes a rotor 52 and a stator 51 attached to the rear of the tub 20. A driving shaft 53 is directly connected with the rotor 52 and the drum 30 to transfer a driving force of the rotor 52 to the drum 30. Instead of the rotor 52 and the stator 51, the driving shaft 53 may be connected with a motor located at the lower portion using a pulley and a belt.

A controller 12 is provided at the upper portion of the cabinet 10 and controls the whole operation of the washing machine. A door 11 is provided at the front of the cabinet 10, and a gasket 100 is provided between the door 11 and the drum 30. The gasket 100 serves to prevent washing water from being leaked into the washing machine.

As shown in FIG. 3, the gasket 100 includes a first end 10, a second end 120, and a bent portion 130 formed between the first and second ends.

The first end 110 is inserted into an opening formed in the cabinet and is engaged with the door 11 that closes the opening. The second end 120 is engaged with the tub 20.

The bent portion 130 serves to give elasticity to the gasket 100 to damp vibration of the tub 20 and the drum 30. Substantially, the bent portion 130 is comprised of a bellows. In more detail, the bent portion 130 is oriented toward the door 11 as shown. The bent portion 130 is forwardly extended from the body of the gasket 100. The bent portion 130 also allows the gasket 100 to damp up and down vibration and forward and reverse vibration.

Meanwhile, as aforementioned, friction occurs between respective facing inner surfaces of the bent portion 130 due to vibration of the drum 30 and tub 20. This could lead to abrasion of the bent portion 30. The bent portion may be damaged by such abrasion. Accordingly, a reinforcement member 200 is provided in the bent portion 130 to prevent the bent portion from being abraded.

The reinforcement member 200, as shown in FIG. 3, is comprised of at least one rib 200 provided in any one of the facing inner surfaces of the bent portion 130. The rib 200 is extended along the inner surface in a radial direction of the gasket 100. Also, the rib 200 may be formed in a single body with the gasket 100 or may separately be attached to the inner surface of the gasket 100. The reinforcement member, i.e., the rib 200 allows the facing inner surfaces of the bent portion to be spaced apart from one another at predetermined intervals. In this case, the facing inner surfaces are not in contact with one another. Thus, the reinforcement member 200 can prevent the bent portion 130 from being abraded and damaged by friction. Preferably, a plurality of ribs 200 are formed in any one of the facing inner surfaces of the bent portion 130. In this case, the ribs are spaced apart from one another at predetermined intervals along a circumferential direction of the gasket 100.

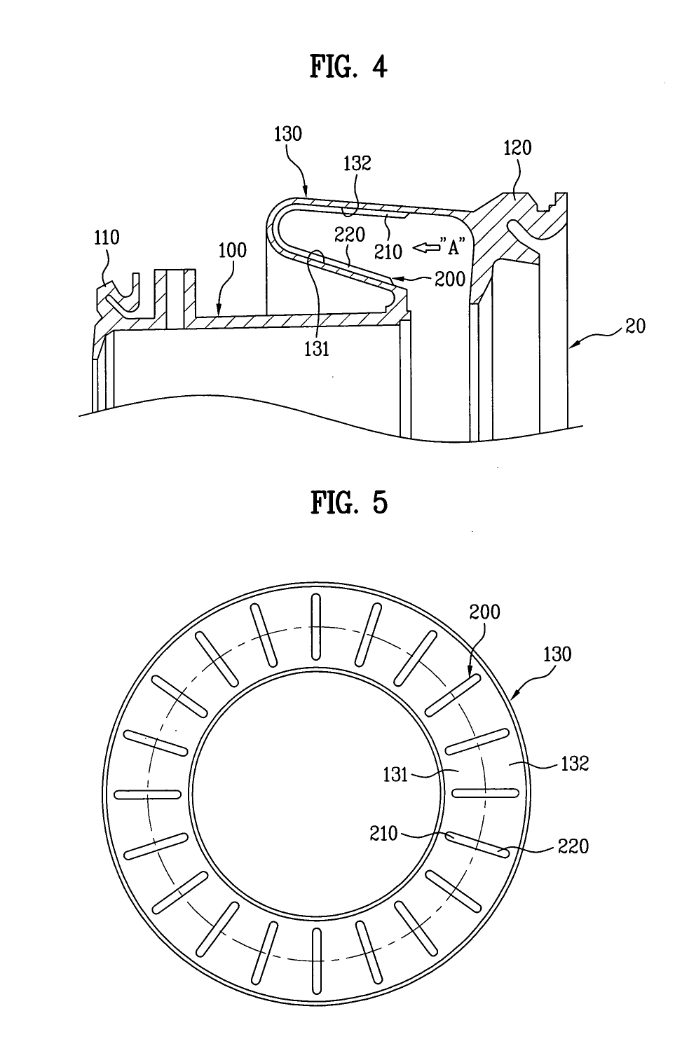

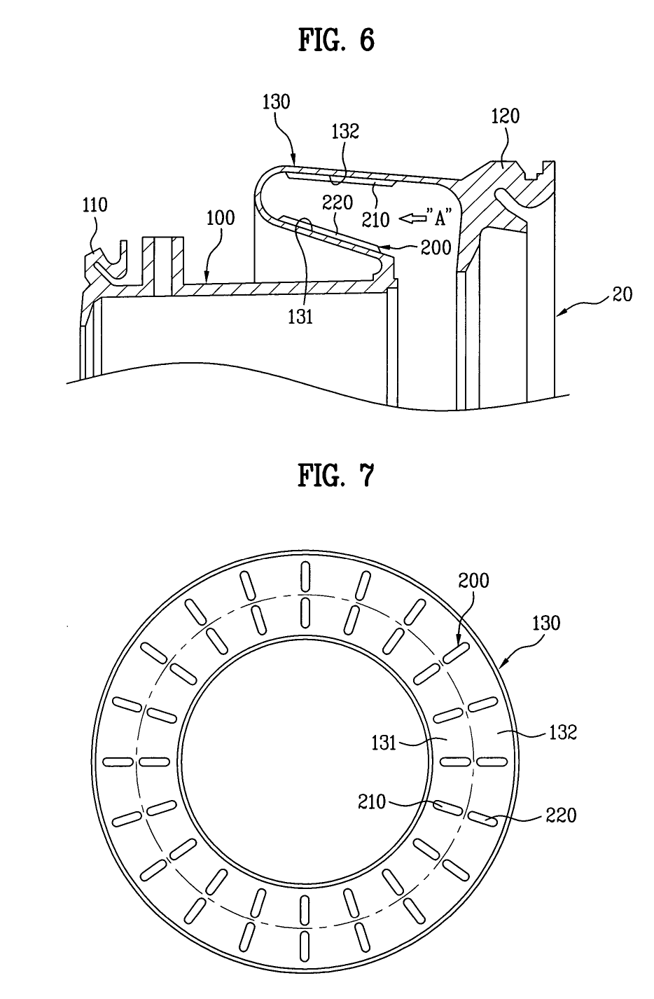

Furthermore, as shown in FIG. 4 and FIG. 6, first and second ribs 210 and 220 may respectively be formed in facing inner surfaces 131 and 132 of the bent portion. The first and second ribs 210 and 220 are arranged to face each other. When the bent portion 130 is varied by vibration, the first and second ribs 210 and 220 are only in contact with each other. Thus, the first and second ribs 210 and 220 fully prevent the facing inner surfaces 131 and 132 from being contacted with each other, and can ensure prevention of abrasion of the bent portion 130. Preferably, a plurality of first and second ribs may be formed in the inner surfaces 131 and 132. In this case, as shown in FIG. 5 and FIG. 7, the first and second ribs are spaced apart from one another at constant intervals. Also, the first and second ribs 210 and 220, as shown in FIG. 6 and FIG. 7, may be separate members spaced apart from each other. Alternatively, as shown in FIG. 4 and FIG. 5, the first and second ribs 210 and 220 may be connected with each other. In other words, the reinforcement member 200 may be comprised of ribs successively extended over the facing inner surfaces of the bent portion 130. The successive first and second ribs 210 and 220 wholly support the bent portion 130 to enhance the intensity of the bent portion 130.

The operation of the aforementioned gasket according to the present invention will be described as follows.

First, if the power is applied to motors 51 and 52, the drum 30 connected with the motors is rotated by the motors to perform a washing function. Vibration generated by rotation of the drum 30 is transferred to the gasket 100 through the tub 20. The bent portion of the gasket is twisted or distorted by the vibration. At this time, the inner surfaces 131 and 132 of the bent portion are in contact with each other due to the reinforcement member 200. Thus, the inner surfaces 131 and 132 of the bent portion 130 are not abraded. Even in case that the laundry enters the bent portion 130, the reinforcement member 200 minimizes contact and abrasion of the inner surfaces 131 and 132 of the bent portion.

As described above, the gasket is neither abraded nor damaged by the reinforcement member. Therefore, owing to the reinforcement member, it is possible to previously avoid failure of the washing machine that may be caused by leakage of the washing water.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. A washing machine comprising:
a cabinet;
a tub provided in the cabinet, storing washing water;
a drum rotatably provided in the tub, washing the laundry;
a door provided in the cabinet;
a gasket provided between the door and the tub, including a bent portion; and
a reinforcement member provided in the bent portion of the gasket, preventing the bent portion from being abraded.

2. The washing machine of claim 1, wherein the reinforcement member is configured to allow facing inner surfaces of the bent portion not to contact with one another.

3. The washing machine of claim 1, wherein the reinforcement member is configured to allow facing inner surfaces of the bent portions to be spaced apart from one another at predetermined intervals.

4. The washing machine of claim 1, wherein the reinforcement member is comprised of at least one rib formed in any one of facing inner surfaces of the bent portion.

5. The washing machine of claim 1, wherein the reinforcement member is extended in a radial direction of the gasket.

6. The washing machine of claim 1, wherein the reinforcement member is comprised of a plurality of ribs formed in any one of facing inner surfaces of the bent portion.

7. The washing machine of claim 6, wherein the ribs are spaced apart from one another along a circumferential direction of the gasket.

8. The washing machine of claim 1, wherein the reinforcement member is comprised of first and second ribs respectively formed in facing inner surfaces of the bent portion.

9. The washing machine of claim 8, wherein the first and second ribs face each other.

10. The washing machine of claim 1, wherein the reinforcement member is comprised of ribs successively extended over facing inner surfaces of the bent portion.

11. The washing machine of claim 8, wherein the first and second ribs are connected with each other.

12. The washing machine of claim 8, wherein the first and second ribs are separate members spaced apart from each other.

13. The washing machine of claim 1, wherein the reinforcement member is formed in a single body with the bent portion.

14. The washing machine of claim 1, wherein the reinforcement member is a separate member attached to the bent portion.

15. The washing machine of claim 1, wherein the gasket includes a first end engaged with the door and a second end engaged with the tub.

16. The washing machine of claim 1, wherein the bent portion is oriented toward the door.

17. The washing machine of claim 1, wherein the bent portion is comprised of a bellows.
